(19) United States
(12) Patent Application Publication
(10) Pub. No.: US 2023/0402057 A1
(43) Pub. Date: Dec. 14, 2023

(54) VOICE ACTIVITY DETECTION SYSTEM

(71) Applicant: Himax Technologies Limited, Tainan City (TW)

(72) Inventors: Ching-Han Chou, Tainan City (TW); Ti-Wen Tang, Tainan City (TW); Bo-Ying Huang, Tainan City (TW)

(21) Appl. No.: 17/839,962

(22) Filed: Jun. 14, 2022

(51) Int. Cl. G10L 25/87; G10L 25/93

(52) U.S. Cl. CPC G10L 25/87; G10L 25/93; G10L 2025/783

(57) ABSTRACT

A voice activity detection (VAD) system includes a voice frame detector that detects a voice frame during which a voice signal is not silent; and a voice detector that detects presence of human speech according to the voice frame.

### BACKGROUND OF THE INVENTION

### 1. Field of the Invention

The present invention generally relates to voice activity detection (VAD), and more particularly to a VAD system with adaptive thresholds.

### 2. Description of Related Art

Voice activity detection (VAD) is the detection or recognition of presence or absence of human speech, primarily used in speech processing. VAD can be used to activate speech-based applications. VAD can avoid unnecessary transmission by deactivating some processes during non-speech period, thereby reducing communication bandwidth and power consumption.

Conventional VAD systems are liable to be erroneous or unreliable, particularly in the noisy environment. A need has thus arisen to propose a novel scheme to overcome drawbacks of the conventional VAD systems.

### SUMMARY OF THE INVENTION

In view of the foregoing, it is an object of the embodiment of the present invention to provide a voice activity detection (VAD) system with adaptive thresholds capable of adapting to varying environment and noise overcoming, thereby outputting a reliable and accurate detection result.

According to one embodiment, a voice activity detection (VAD) system includes a voice frame detector and a voice detector. The voice frame detector detects a voice frame during which a voice signal is not silent. The voice detector detects presence of human speech according to the voice frame.

In one embodiment, the VAD system further includes a threshold update unit that updates an associated threshold for detecting the presence of human speech according to result of human speech detection by the voice detector.

### BRIEF DESCRIPTION OF THE DRAWINGS

FIG. 1 shows a block diagram illustrating a voice activity detection (VAD) system according to one embodiment of the present invention;

FIG. 2 shows a flow diagram illustrating a voice activity detection (VAD) method according to one embodiment of the present invention;

FIG. 3A shows an exemplary waveform of the voice signal with end points (EPs);

FIG. 3B shows exemplary values of volume and HOD of the voice signal;

FIG. 3C shows exemplary voice frames;

FIG. 4A shows an exemplary waveform of the voice signal and the associated end points (EPs);

FIG. 4B shows exemplary auto-correlation and the associated first threshold TH_B;

FIG. 4C shows exemplary normalized squared difference and the associated second threshold TH_C;

FIG. 5A shows exemplary auto-correlation and how an updated first threshold is obtained;

FIG. 5B shows exemplary normalized squared difference and how an updated second threshold is obtained;

FIG. 6 shows a block diagram illustrating a VAD system according to a first exemplary embodiment of the present invention; and

FIG. 7 shows a block diagram illustrating a VAD system according to a second exemplary embodiment of the present invention.

### DETAILED DESCRIPTION OF THE INVENTION

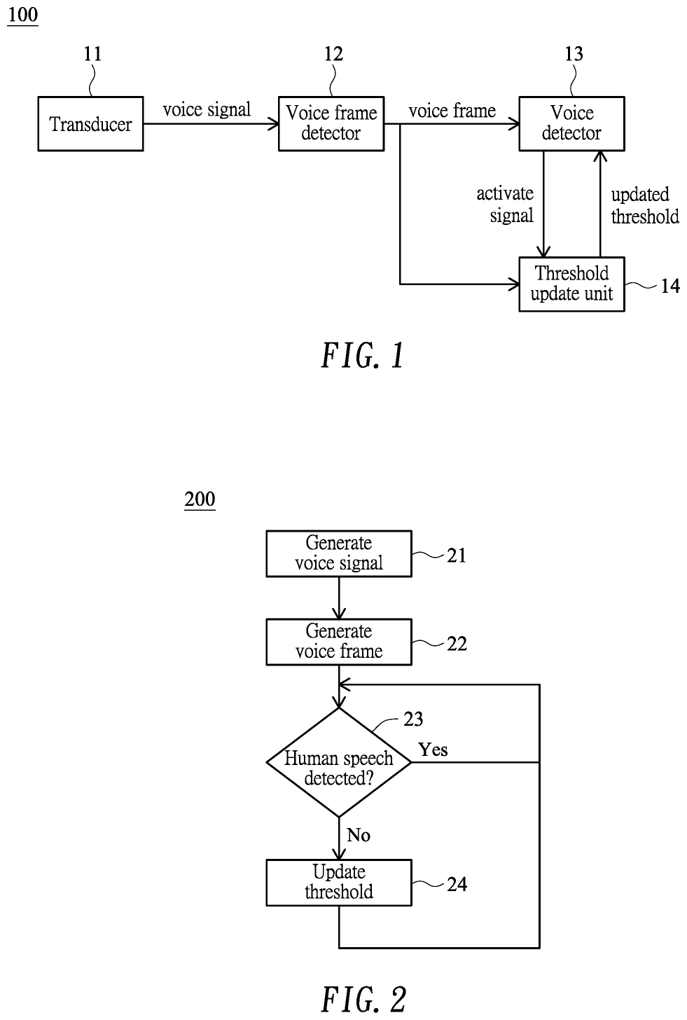

FIG. 1 shows a block diagram illustrating a voice activity detection (VAD) system 100 according to one embodiment of the present invention, and FIG. 2 shows a flow diagram illustrating a voice activity detection (VAD) method 200 according to one embodiment of the present invention.

Specifically, the VAD system 100 of the embodiment may include a transducer 11, such as a microphone, configured to convert sound into a voice (electrical) signal (step 21).

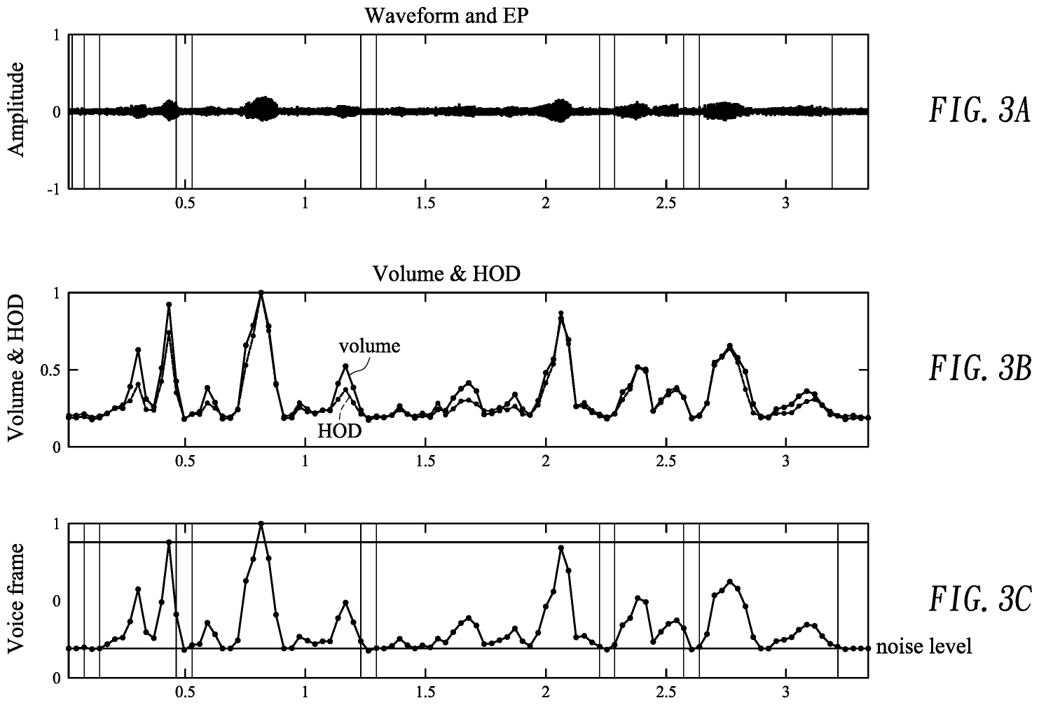

The VAD system 100 may include a voice frame detector 12 coupled to receive the voice signal and configured to detect a voice frame during which the voice signal is not silent (step 22). In one embodiment, the voice frame detector 12 may adopt end-point detection (EPD) to determine end points of the voice signal between which the voice signal is not silent. In one embodiment, amplitude (representing volume) of the voice signal greater than a predetermined threshold is determined as an end-point. In another embodiment, high-order difference (HOD) (representing slope) of the voice signal greater than a predetermined threshold is determined as an end-point. FIG. 3A shows an exemplary waveform of the voice signal with end points (EPs), FIG. 3B shows exemplary values of volume and HOD of the voice signal, and FIG. 3C shows exemplary voice frames.

The VAD system 100 of the embodiment may include a voice detector 13 configured to detect presence of human speech according to the voice frames (step 23).

In the embodiment, presence of human speech is detected (by the voice detector 13) when a value of similarity (or correlation) between voice frames is greater than an associated threshold. Specifically, auto-correlation (function) is performed on the voice frames to determine an auto-correlation value representing similarity (or detect pitch) between a voice frame and a (delayed) voice frame with a time lag. The auto-correlation function (ACF) may be expressed as follows:

$$ACF ( τ ) = {\sum }_{i = 0}^{n - 1 - τ} s ( i ) s ( i + τ )$$

where τ is the time lag, s is the voice frame, and i=0, . . . , n−1.

In the embodiment, a normalized squared difference (function) is further performed on the voice frames (e.g., a voice frame and a (delayed) voice frame with a time lag) to determine a normalized squared difference value, and the normalized squared difference function (NSDF) may be expressed as follows:

$$NSDF ( τ ) = \frac{2 \sum s ( i ) s ( i + τ )}{\sum {s}^{2} ( i ) + \sum {s}^{2} ( i + τ )}$$

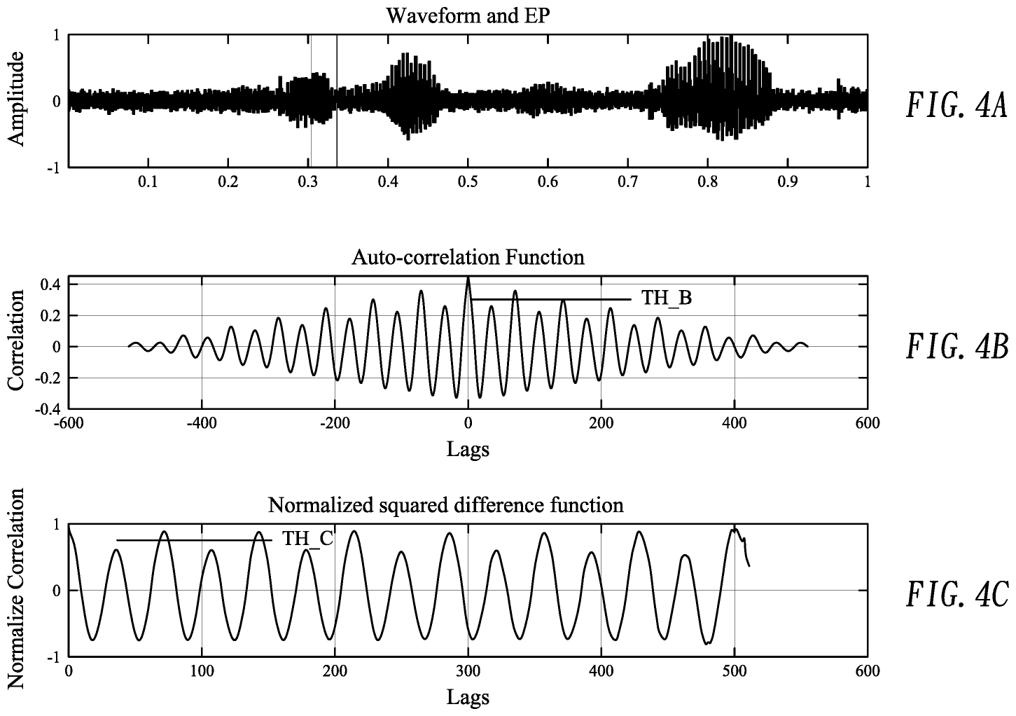

In the embodiment, presence of human speech is detected when (both) the auto-correlation value is greater than a first threshold, and the normalized squared difference value is greater than a second threshold. FIG. 4A shows an exemplary waveform of the voice signal and the associated end points (EPs), FIG. 4B shows exemplary auto-correlation and the associated first threshold TH_B, and FIG. 4C shows exemplary normalized squared difference and the associated second threshold TH_C.

Referring back to FIG. 2, if the presence of human speech is detected, detecting presence of human speech is then performed for another voice frame. On the other hand, if the presence of human speech is not detected (indicating that noise is present or is detected), the threshold associated with the similarity between voice frames is then updated (or adjusted) in step 24, before detecting presence of human speech for another voice frame. Accordingly, the thresholds of the VAD system 100 and the VAD method 200 are adaptively determined according to result of human speech detection and thus adapting to current environment, instead of being fixed as in conventional VAD systems or methods.

Specifically, the VAD system 100 of the embodiment may include a threshold update unit 14 configured to determine updated (first/second) thresholds (when the presence of human speech is not detected) activated by an activate signal (from the voice detector 13), which is asserted when the presence of human speech is not detected.

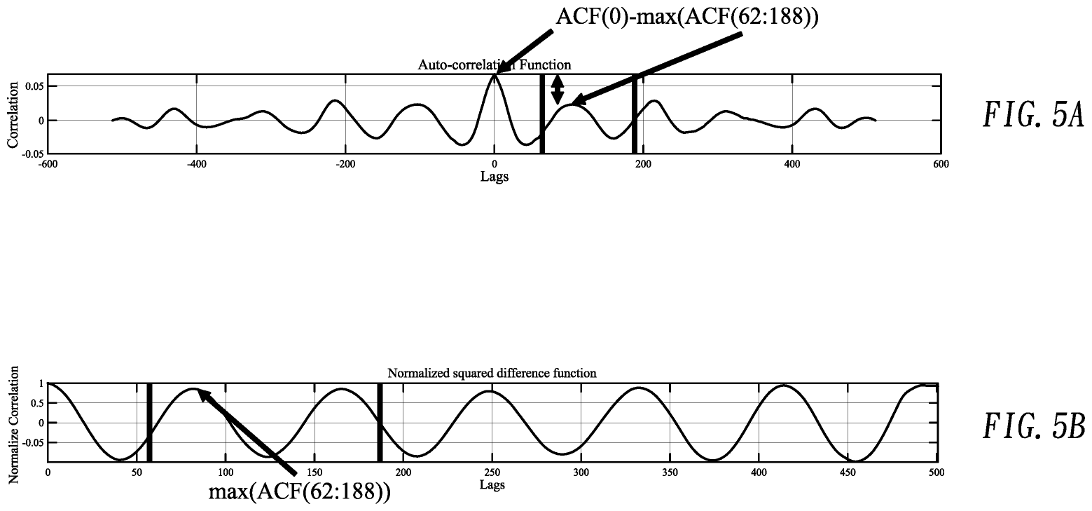

FIG. 5A shows exemplary auto-correlation and how an updated first threshold is obtained. Specifically, in the embodiment, the updated first threshold is equal to an auto-correlation value without time lag (i.e., ACF(0)) minus a maximum auto-correlation value within a specified range (e.g., max(ACF(62:188))) as exemplified.

FIG. 5B shows exemplary normalized squared difference and how an updated second threshold is obtained. Specifically, in the embodiment, the updated second threshold is equal to a maximum auto-correlation value within a specified range (e.g., max(ACF(62:188))) as exemplified.

According to the embodiment as described above, as the thresholds for detecting presence of human speech are adaptively determined, the VAD system 100 and the VAD method 200 can be adapted to varying environment and noise overcoming, thereby outputting a reliable and accurate detection result.

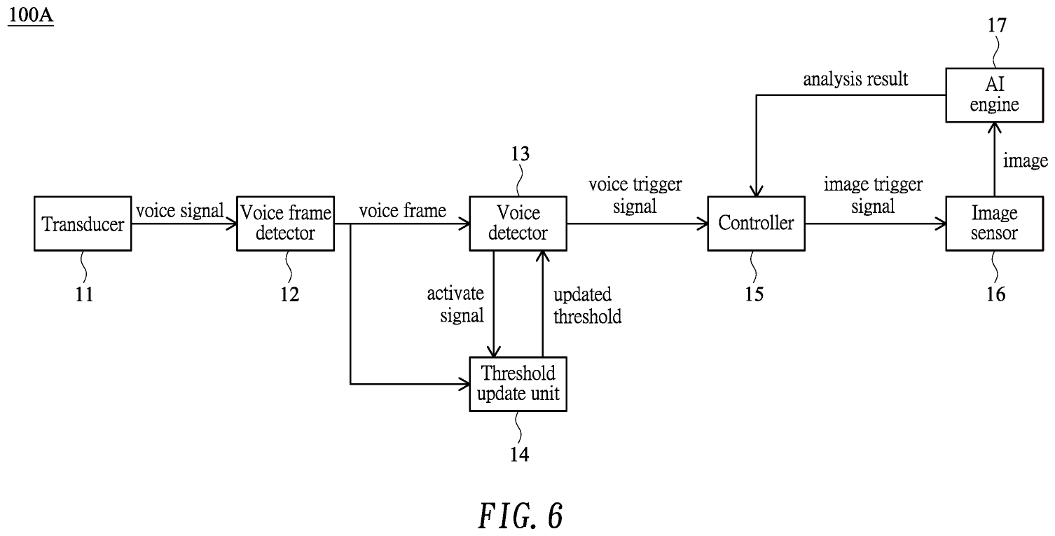

FIG. 6 shows a block diagram illustrating a VAD system 100A according to a first exemplary embodiment of the present invention. Specifically, in the embodiment, (only) if the presence of human speech is detected, the voice detector 13 sends a voice trigger signal to a controller 15, which then wakes up an image sensor 16, such as a contact image sensor (CIS), by an image trigger signal (sent by the controller 15), thereby capturing images. It is noted that, the image sensor 16 is normally in a low-power mode or sleep mode except when the image trigger signal becomes asserted. Therefore, power consumption and communication bandwidth may be substantially reduced.

In the embodiment, the VAD system 100A may include an artificial intelligence (AI) engine 17, for example, an artificial neural network, configured to analyze the images captured by the image sensor 16, and to send analysis results to the controller 15, which then performs specific functions or applications according to the analysis results.

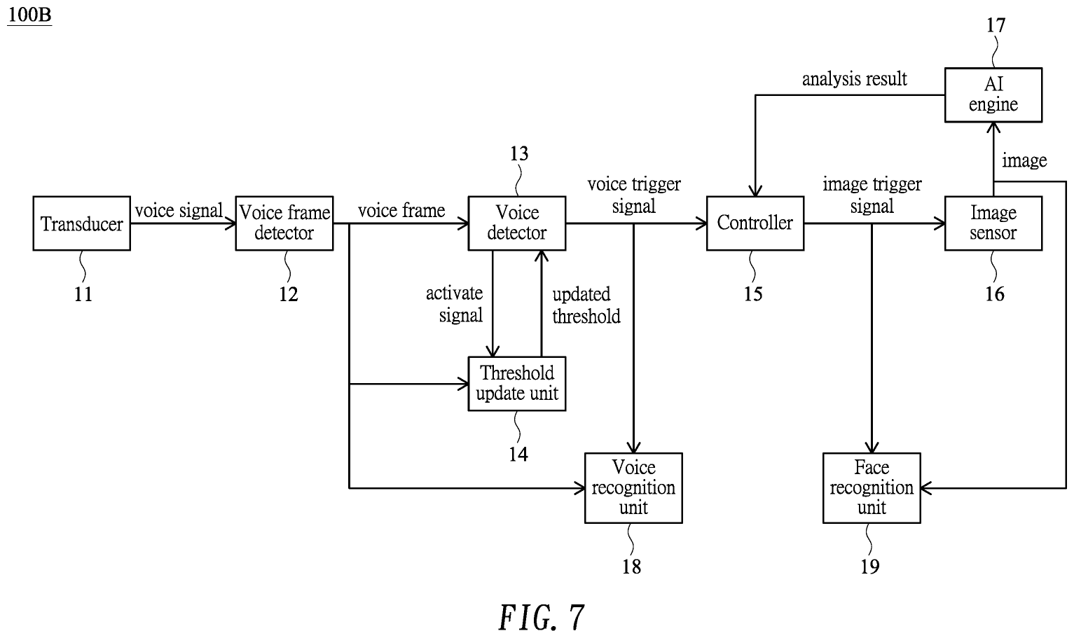

FIG. 7 shows a block diagram illustrating a VAD system 100B according to a second exemplary embodiment of the present invention. The VAD system 100B of FIG. 7 is similar to the VAD system 100A of FIG. 6 with the following exceptions.

Specifically, the VAD system 100B may further include a voice recognition unit 18 configured to recognize spoken language and even translate spoken language into text, or configured to recognize a speaker, or both according to the voice frames (from the voice frame detector 12). The voice recognition unit 18 is activated only when the voice trigger signal (from the voice detector 13) becomes asserted.

The VAD system 100B of the embodiment may further include a face recognition unit 19 configured to recognize a human face from the images captured by the image sensor 16. The face recognition unit 19 is activated only when the image trigger signal (from the controller 15) becomes asserted.

Although specific embodiments have been illustrated and described, it will be appreciated by those skilled in the art that various modifications may be made without departing from the scope of the present invention, which is intended to be limited solely by the appended claims.

What is claimed is:

1. A voice activity detection (VAD) system, comprising:
a voice frame detector that detects a voice frame during which a voice signal is not silent; and
a voice detector that detects presence of human speech according to the voice frame.

2. The VAD system of claim 1, further comprising:
a transducer that converts sound into the voice signal.

3. The VAD system of claim 1, wherein the voice frame detector adopts end-point detection to determine end points of the voice signal between which the voice signal is not silent.

4. The VAD system of claim 3, wherein amplitude or high-order difference of the voice signal greater than a predetermined threshold is determined as an end-point.

5. The VAD system of claim 1, wherein the presence of human speech is detected by the voice detector when a value of similarity between voice frames is greater than an associated threshold.

6. The VAD system of claim 1, further comprising:
a threshold update unit that updates an associated threshold for detecting the presence of humane speech according to result of human speech detection by the voice detector.

7. The VAD system of claim 6, wherein the threshold update unit updates the associated threshold if the presence of human speech is not detected.

8. The VAD system of claim 6, wherein the voice detector performs auto-correlation on the voice frames to determine an auto-correlation value representing similarity between a voice frame and a delayed voice frame with a time lag.

9. The VAD system of claim 8, wherein the voice detector performs normalized squared difference on a voice frame and a delayed voice frame with a time lag to determine a normalized squared difference value.

10. The VAD system of claim 9, wherein the presence of human speech is detected when the auto-correlation value is greater than a first threshold, and the normalized squared difference value is greater than a second threshold.

11. The VAD system of claim 10, wherein the first threshold is updated as an updated first threshold that is equal to an auto-correlation value without time lag minus a maximum auto-correlation value within a specified range, and the second threshold is updated as an updated second threshold that is equal to a maximum auto-correlation value within a specified range.

12. The VAD system of claim 1, further comprising:
a controller that receives a voice trigger signal from the voice detector if the presence of human speech is detected; and
an image sensor that is woke up from a low-power mode by an image trigger signal sent from the controller to capture images if the presence of human speech is detected.

13. The VAD system of claim 12, further comprising:
an artificial intelligence (AI) engine that analyzes the images captured by the image sensor, and sends analysis results to the controller, which then performs specific functions or applications according to the analysis results.

14. The VAD system of claim 13, further comprising:
a voice recognition unit that is activated only when the voice trigger signal becomes asserted, the voice recognition unit recognizing spoken language or recognizing a speaker according to the voice frame.

15. The VAD system of claim 13, further comprising:
a face recognition unit that is activated only when the image trigger signal becomes asserted, the face recognition unit recognizing a human face from the images captured by the image sensor.
